(19) United States
(12) Patent Application Publication
(10) Pub. No.: US 2007/0009577 A1
(43) Pub. Date: Jan. 11, 2007

(54) Probiotic compositions and methods

(76) Inventor: Roy J. Mankovitz, Montecito, CA (US)

Correspondence Address: Julie K. Staple;Gifford, Krass, Groh, Sprinkle, Anderson & Citkowski, P.C., PO Box 7021, Troy, MI, 48007-7021, US

(21) Appl. No.: 11/415,034

(22) Filed: May 1, 2006

Related U.S. Application Data
(60) Provisional application No. 60/696,658, filed on Jul. 5, 2005.
(60) Provisional application No. 60/731,762, filed on Oct. 31, 2005.

(51) Int. Cl. A23K 1/165; A23K 1/17

(52) U.S. Cl. 424/442; 426/635

(57) ABSTRACT

A variety of human and animal diseases are associated with distortion of diversity of intestinal flora caused by such factors as unnatural diet and exposure to antibiotics. Probiotic compositions according to the present invention and methods for their generation are described which are designed to provide exposure to microorganisms in order to promote health of humans and other animals. Probiotic compositions are provided which include microorganisms isolated from the digestive system of an animal which is a traditional food source for a second type of animal. Such isolated microorganisms may be used directly in a probiotic composition and/or related method, and may also be cultured and/or amplified for such use.

### REFERENCE TO RELATED APPLICATIONS

This application claims priority to U.S. Provisional Patent Application Ser. Nos. 60/696,658, filed Jul. 5, 2005, and 60/731,762, filed Oct. 31, 2005, the entire content of both of which are incorporated herein by reference.

### FIELD OF THE INVENTION

The present invention generally relates to probiotic compositions and processes for their manufacture. In one specific embodiment, the present invention relates to probiotic compositions including microorganisms isolated from the digestive system of an animal which is a traditional food source for a type of animal which is an intended recipient of an inventive composition.

### BACKGROUND OF THE INVENTION

While modern science has elucidated many biological processes at the cellular and even molecular level, the interactions between microbial organisms and mammalian organisms have been largely uncharacterized, although there is considerable evidence of their importance.

In particular, it is well established that various types of microbes ordinarily live in the mammalian gut. Such microbes, termed intestinal flora, are known to have effects on the organism that they colonize. For example, some bacteria synthesize and make certain essential nutrients available to the host animal. In humans, for instance, vitamin K is an essential compound which may be provided by bacterial synthesis in the gut.

A role for microorganisms in digestion has been extensively studied in some animals, such as ruminants. In other species exact functions of digestive system microorganisms are less understood.

The gastrointestinal system varies between species but generally includes several different sections having specific functions in the digestive process of the animal. In particular, digestive systems are configured differently depending on the usual food source of the animal. For example, a typical carnivore digestive system is configured to digest protein efficiently along with fats and some carbohydrates. A carnivore system is characterized by anatomical structures functional to mechanically dissociate food, such as teeth, a single acid secreting stomach which includes acid activated enzymes functional to break down proteins, the small intestine for further digestion and absorption of the food, and the large intestine which also functions to absorb some nutrients. Microorganisms present in regions of the carnivore digestive system function to digest some substrates indigestible by the carnivore, as well as provide some essential nutrients.

In contrast, an herbivore gastrointestinal system is configured to utilize carbohydrates derived from plants. In this regard, herbivores include ruminants, a type of animal that has a specialized multigastric configuration of the digestive system, and non-ruminant herbivores. Ruminants are characterized by a multigastric system having 3 to 4 compartments, including the rumen, reticulum, omasum and abomasum. The multigastric configuration functions to allow repetitive mechanical breakdown of plant material and provides an environment conducive to fermentation of the plant material by resident microorganisms.

In addition to a role in digestive metabolism, microorganisms are believed to play a more general role in the health of host animals. A number of diseases and disorders are believed to be related to alterations of number and/or types of microorganisms represented in the intestinal flora. For example inflammatory bowel diseases, such as Crohn's disease and ulcerative colitis are associated with reduced diversity of intestinal flora. (Ott, S. J. et al., Reduction in diversity of the colonic mucosa associated bacterial microflora in patients with active inflammatory bowel disease. Gut, 53:685-693, 2004.) Further, modern “lifestyle” disorders such as cancer, heart disease, hypertension, diabetes, senile dementia, microbial or viral infection, auto-immune disorder, atopic dermatitis, as well as various allergies and food sensitivities, more prevalent in recent history, are thought to be associated with changes in intestinal flora.

Both human and cultivated animal diets have changed significantly in recent history. Modern humans and the animals they raise for food or as companions now consume highly processed foods and/or foods never or rarely consumed in the natural or primitive environment. Further, the advent of high volume food manufacturing and relatively inexpensive snack foods has contributed to changes in the overall composition of foods included in a modem diet compared to previous eras. For instance, populations of modem humans eat more simple carbohydrates than were available historically. A cultivated animal's diet is now constructed according to convenience and to promote fast growth, rarely providing the foods the animal would eat in the natural state or as cultivated in a primitive society. A companion animal's diet is sanitized and largely adapted to human concepts of a pet's food preferences. These relatively recent changes are believed to cause distortions of the intestinal flora in humans and animals exposed to modem habits since modem diets support different populations of microorganisms than a traditional or primitive diet based on natural foods.

In addition to changes in diet, both humans and cultivated animals are routinely exposed to antibiotics which affect not only pathogenic microorganisms but benign and beneficial microorganisms as well. The systemic treatment of an individual during a course of antibiotics may result in elimination of gut microorganisms, many varieties of which may not be replaced if exposure to microorganisms is limited.

The diversity of modem intestinal flora in humans and other animals is believed to be limited by the paucity of sources of potential exposure to microorganisms. Currently human and even animal hygiene standards are at their historical zenith, with both desirable and unanticipated less desirable results. There is evidence that limited exposure of humans to dirt, dust, animals, and the various antigens found therein, such as bacteria and viruses, can predispose an individual to immune disorders, such as allergies and asthma.

Current dietary preferences and/or habits based on available food products also have a role in limiting exposure of modem humans and other animals to microorganisms. In particular, modem humans who eat meat typically prefer the muscle meat of an animal rather than the organ meat. In contrast, earlier societies valued all parts of the body of a source animal, including internal organs such as the heart, liver, kidneys, and, importantly, the digestive system including the tongue, the stomach, intestines and intestinal contents. For example, an account of a traditional Native American diet describes the use of buffalo entrails as food including intestines “full of half-fermented, half-digested grass and herbs . . . ” (John Lame Deer & Richard Erdoes, Lame Deer, Seeker of Visions, p. 122, Simon & Schuster, 1972) Further, both cultivated and wild animals which are sources of nutrition for humans and pets historically had access to food likely to expose the animals to microorganisms, such as pasture grass and other wild growing plants which were not processed to remove or inhibit microorganisms.

Thus, in view of the disorders associated with distortion of diversity of intestinal flora, there is a continuing need for compositions and methods designed to provide exposure to microorganisms in order to promote health of humans and other animals.

### SUMMARY OF THE INVENTION

A probiotic composition is provided according to the present invention which includes a plurality of microorganisms isolated from a source animal. The source animal is a traditional food source of a second type of animal and is characterized as having a native habitat. A carrier for the plurality of microorganisms is also preferably included in a probiotic composition described herein. The carrier is substantially non-toxic to the second type of animal in amounts used in the composition.

In one embodiment of an inventive composition, an included carrier includes a nutritive medium for at least a portion of the plurality of microorganisms. A preferred nutritive medium includes a food consumed by the source animal as part of a natural diet in the wild. For example, a nutritive medium may include grass.

The source animal is preferably a weaned ruminant in one embodiment which has been fed a natural diet over a period of time extending from weaning to a time at which microorganisms are isolated from the digestive system of the source animal. A suitable weaned ruminant may be, for instance, a cow, a sheep, a goat, a bison, a buffalo, a cape buffalo, a deer, an elk, an antelope, a moose, or a llama. A source animal may also be a pig, a chicken, a turkey, a game bird, a fish, a shellfish, a horse, a rodent, a rabbit, or a hare.

In one embodiment, the second type of animal, which is the type of animal intended to consume the probiotic composition, is a human. The second type of animal may also be an animal commonly kept as a household pet, such as a cat or dog.

A process for producing a probiotic composition is provided according to the present invention which includes isolating a sample of microorganisms from the digestive system of a source animal, wherein the source animal is a traditional food source of a second type of animal, to produce an isolated sample of microorganisms.

An inventive method may further include amplifying the isolated sample of microorganisms to produce an amplified sample of microorganisms.

### DETAILED DESCRIPTION OF THE INVENTION

Probiotic compositions, as well as methods of generating them and using them, are provided according to the present invention.

Probiotic Compositions

Probiotic compositions are provided which include microorganisms isolated from the digestive system of an animal which is a traditional food source for a second type of animal. Such isolated microorganisms may be used directly in a probiotic composition and/or related method, and may also be cultured and/or amplified for such use.

The animal from which microorganisms are obtained is called a “source animal” herein, to indicate both that this animal is a source of microorganisms included in an inventive composition and that the animal is a traditional food source for a second type of animal which is an intended recipient of an inventive composition as described in more detail below. The terms “second type of animal” and “individual of a second type of animal” as used herein refer to an intended recipient of an inventive composition.

The term “traditional food source” as used herein is intended to mean an animal eaten for nutritive purposes in a natural setting by a second type of animal. Thus, for example, any of various herbivores are a traditional food source for any of various carnivores or omnivores. In contrast however, a carnivore is not considered a traditional food source for an herbivore.

Illustratively, microorganisms are isolated from the digestive system of a ruminant. Ruminants are herbivores which are a traditional source of food for a number of other animals, especially humans, but also including other relatively large carnivores and/or omnivores. Ruminants include cattle, sheep, goats, bison, buffalo, deer, elk, antelope, moose, and llamas for instance.

In other examples, microorganisms are isolated from the digestive system of an animal such as a pig, a poultry animal such as a chicken or a turkey, a bird, including a game bird, a fish, a shellfish, a horse, a rodent, a rabbit, and a hare. Such animals are a traditional source of food for humans and other relatively large carnivores and/or omnivores.

In a further example, microorganisms are isolated from the digestive system of an animal such as pigs, poultry, birds, fish, rodents, rabbits, hares, small reptiles and amphibians which are traditional food sources for smaller carnivores and/or omnivores such as domesticated dogs and cats. In addition, some ruminants described above are a traditional source of food for dogs. For instance, dogs may kill and eat cattle, sheep, goats, bison, buffalo, deer, elk, antelope, moose, and/or llamas.

A source animal is preferably raised in an environment as similar as possible to the environment in which the species historically lived prior to domestication. Thus a preferred source animal has never been exposed to exogenously administered growth hormones, antibiotics, pesticides, or other drugs.

It is highly preferred that the source animal is an animal fed a “natural” diet” over the span of its life. Cultivated ruminants are currently fed a distorted diet in order to promote maximum growth. For example, a typical feed preparation for a growing cow may contain about 20% grain and 80% silage or other roughage such as hay. In the final stage of preparing the cow for market, it may be fed a “finishing” diet including about 80% grain or more. Such a feeding regimen includes a disproportionate amount of grain compared to the diet a foraging animal in an uncultivated pasture would consume. Further, it is believed that high grain content in a food source animal's diet results in changes in composition of the food products produced from the animal. For instance, it has been shown that grain fed beef can have a higher amount of saturated fatty acids and an unfavorable ratio of saturated fatty acids to unsaturated fatty acids. P. French et al., Fatty acid composition, including conjugated linoleic acid, of intramuscular fat from steers offered grazed grass, grass silage, or concentrate-based diets, J. Anim. Sci., 2000, 78:2849-2855. Thus, it is particularly preferred to isolate microorganisms from an animal fed on a “natural” diet.

The term “natural diet” as used herein is intended to mean that the source animal is fed food growing wild in the animal's native habitat, and which excludes foods not normally found in such a native habitat.

The term “native habitat” is intended to preferentially include the habitat of the breed of a source animal prior to human domestication. By way of example, but not limitation, cattle would not naturally be found in habitats that receive large amounts of snow, since they have no way to reach grass under the snow in winter.

Optionally, a source animal may be an animal whose native habitat is located on the continent of Africa. In particular, a source animal may be an animal whose native habitat is located in the tropical region of Africa, that is, the region on either side of the equator extending between two parallels of latitude on the earth, one 23°27′ north of the equator and the other 23°27′ south of the equator.

A source animal may be a carnivore, herbivore or omnivore.

In a particular example, a source animal having an African native habitat is an herbivore of the order Artiodactyla. Common names for African animals of this type include topi, hartebeest, wildebeest, waterbuck, gerenuk, gemsbok, impala, gnu, gazelle, giraffe, okapi, kudu and eland. A source animal of particular interest may be the African cape buffalo (Syncerus caffer). These and other African and non-African animals may be a source animal, including those animals described in standard references such as: Jones, C. 1984. Tubulidentates, Proboscideans, and Hyracoideans, in Orders and Families of Recent Mammals of the World. Edited by Anderson, S. and J. K. Jones, Jr. John Wiley and Sons, N.Y. pp. 523-535; Nowak, R. M. 1991. Walker's Mammals of the World. Fifth Edition. Johns Hopkins University Press, Baltimore; Thenius, E. 1990. Even-toed Ungulates. In Grzimek's Encyclopedia of Mammals. Volume 5. Edited by Parker, S. P. New York: McGraw-Hill. Pp. 1-15; and Webb, J. E., J. A. Wallwork, and J. H. Elgood. 1979, Guide to Living Mammals, Second Edition. Bell and Blain Ltd., Glasgow.

In this context it is to be understood that a source animal is preferably an animal that has been weaned. An unweaned animal typically has a different set of microorganisms in the gut since the animal has not yet been exposed to many of the typical sources of gut flora. Thus, milk, milk products, and milk components, such as whey, are not among foods considered “natural” for a weaned source animal.

The components of a natural diet will depend on the source animal. Animals in the wild will select a diet which they are adapted to digest and which corresponds to their usual food seeking behavior.

Common food seeking behavior of some animals includes “grazing” and “browsing”. For example, wild grazers will eat a diet composed primarily of grasses and other ground plants such as clover. Grazers include cattle and bison among others. Wild browsers will eat grasses and ground plants, and in addition, will eat leaves and small twigs from trees and bushes. Browsing animals include deer and goats among others.

Exemplary African source animals also display various food selection preferences. For instance browsers include such source animals as the giraffe and Guenther's dik-dik and grass or ground plant preferring animals include the hartebeest and wildebeest.

The diets of herbivores also contain other material ingested along with grasses and ground plants, such as small amounts of seeds and insects.

In addition to larger herbivores discussed above, smaller herbivores, such as rabbits and hares are considered source animals for humans and certain pets, including cats and dogs. The natural diet of such herbivores includes grasses and ground plants.

Rodents such as mice, rats and squirrels are typically natural omnivores, eating a natural diet they will consume such foods as insects, terrestrial non-insect arthropods, leaves, roots and tubers, wood, bark, stems, grains, nuts, fruit, seeds, fungi, young birds, eggs, amphibians and reptiles. Among rodents, rats are known to each nearly anything edible as part of a natural diet including birds, mammals, amphibians, reptiles, fish, eggs, carrion, insects, terrestrial non-insect arthropods, mollusks, terrestrial worms, aquatic crustaceans, echinoderms, other marine invertebrates, zooplankton, and fungus.

Small birds eating a natural diet consume such foods as insects, seeds, buds, berries, fruit, flower nectar, cereals, grain, and grass.

Poultry, including domestic or wild chickens, turkeys, guinea fowl, pheasants, quail, pigeons, doves and peacocks, are typically omnivores whose natural diet includes fruits, seeds, leaves, shoots, flowers, tubers, roots, arthropods, snails, worms, lizards, snakes, small rodents, avian nestlings and eggs, for example. Poultry also include aquatic birds such as ducks and geese, which are typically herbivores whose natural diet includes such foods as vegetation, including leaves, roots and tubers, seeds, grains, nuts and algae. These animals are also occasional omnivores whose natural diet may include worms, gastropods, arthropods, and small fish.

Pigs include members of the family Suidae. Pigs are typically omnivores whose natural diet includes bulbs, carrion, earthworms, eggs, fruit, fungi, leaves, roots, tubers, snails, and small vertebrates such as nesting birds and small rodents.

Small reptiles include skinks and lizards which are generally insectivorous, eating spiders, millipedes, crickets, termites, grasshoppers, caterpillars, non-insect arthropods, beetles, and beetle larvae; and snakes which eat small birds, small mammals, amphibians, fish, insects, terrestrial non-insect arthropods, mollusks, and terrestrial worms.

Amphibians, such as frogs and toads consume a natural diet including insects, annelids and gastropods.

The natural diet of fish includes fish, fish eggs, aquatic vegetation, and aquatic invertebrates such as plankton, brine shrimp, and krill.

A source animal may be bred and/or maintained as a cultivated animal by humans in order to obtain microorganisms and/or other contents of the gastrointestinal tract. Optionally, a source animal is caught in its native habitat, a sample of microorganisms and/or other contents of the gastrointestinal tract obtained for use in an inventive composition and/or amplification for use in an inventive composition. The animal may then be returned to the wild. In a further option, a source animal is caught in its native habitat and then maintained in captivity. Where a source animal is cultivated and/or maintained in captivity, it is fed a natural diet.

Grasses eaten as part of a natural diet include those of the family of “true grasses”, that is, those classified in the family Poaceae (also known as Graminae). There are about 700 genera and nearly 12,000 species of grasses. Such grasses generally have hollow stems with nodes at intervals in the stems where leaves may be located. The fruit of such grasses is known as a grain. The family Fabaceae also includes a number of plants found in the natural diet of herbivores including clover and alfalfa.

Some of the grasses in the family Poaceae are mass cultivated as food and are known as cereals, including maize (or corn), wheat, oats, rye, rice, and barley. It is these and similar cultivated cereal grains which are typically included in disproportionate amounts in the modern diet of a food source animal compared to a natural diet. It is particularly preferred that the animal is fed a diet of natural foods in the proportion that the animal would feed on in a natural diet. Thus, since cereal grain is relatively rare in the wild habitat, a grazing herbivore, such as a buffalo or cow, would have little cereal grain in its natural diet. An herbivore source animal from which microorganisms are isolated is therefore preferably an animal fed predominantly grass with little or no cereal grain. For instance, a preferred diet includes less than 5% cereal grain, and preferably less than 2% cereal grain. Highly preferred is a source animal fed substantially no cereal grain.

In addition to the composition of the source animal's diet, the quality of food consumed by a source animal is considered important as well since this can influence the number and identity of microorganisms present in the gut. A preferred source animal is one fed a diet of organically gown food throughout its life, that is, food which is minimally processed, not genetically modified, grown without pesticides and herbicides, and grown using only natural fertilizer if any is used.

Microorganisms and Isolation of Microorganisms

An isolated sample of microorganisms may be obtained from any of various regions of the digestive system of the source animal. For example, microorganisms may be isolated from the mouth, the esophagus, the pharynx, the stomach, the rumen, the omasum, the abomasum, the reticulum, the small intestine, the large intestine, the caecum, or combinations of these.

In one embodiment, the contents of a portion of the digestive system are obtained and a sample of microorganisms is isolated from the contents. For example, contents of the digestive system of an animal include ingested food particles, partially digested material and fecal material. In a further embodiment, microorganisms may be isolated from a digestive system tissue. Thus, for example, scrapings from the walls of the digestive system are one type of sample of microorganisms from a digestive system tissue. Optionally, an isolated sample of microorganisms obtained from the digestive system of a source animal may be combined with isolated samples from other animals.

In a further embodiment a sample of microorganisms is obtained from the digestive system of the source animal and amplified by growing the microorganisms on a culture medium to yield an amplified microorganism culture.

In a highly preferred embodiment the culture medium includes one or more foods traditionally consumed as a natural diet by the type of animal from which the microorganisms are obtained.

Thus, for example where the sample is obtained from the digestive system of an herbivore, a culture medium includes a grass and/or ground plant, such as clover, or an extract thereof. A grass included as a culture medium is preferably an organically grown and minimally processed natural grass of a type that would be found in the animal's native habitat. Grasses which may be included in a culture medium include those of the family of “true grasses”, that is, those classified in the family Poaceae (also known as Graminae). Another exemplary component is a plant from the family Fabaceae, such as a clover and/or alfalfa, which may also be included in a culture medium for microorganisms. However, a culture medium preferably includes little or no cereal grain from the grass family. For instance, a preferred culture medium contains less than 5% of a cereal grain and further preferably contains less than 2%. Highly preferred is a culture medium which contains substantially no cereal grain. Further, since microorganisms are obtained from weaned animals, a culture medium contains substantially no milk, milk products or milk components.

In an example where a source animal is a carnivore or omnivore, a culture medium includes typical contents of such an animal's digestive system and particularly, includes components of the animal's natural diet.

Techniques and other culture media and components thereof for amplification of microorganisms from a sample obtained from the digestive system of an animal are exemplified in J. P. Salanitro et al., Bacteria isolated from the duodenum, ileum, and cecum of young chicks, Appl. Environ. Microbiol. 35(4): 782-790, 1978; W. E. C. Moore and L. V. Holdeman, Human Fecal Flora: The Normal Flora of 20 Japanese-Hawaiians, Appl. Microbiol. 27(5): 961-979, 1974; M. Morotomi et al., Distribution of indigenous bacteria in the digestive tract of conventional and gnotobiotic rats, Infect. Immun. 11(5): 962-968, 1975; P. Quinn, Clinical Veterinary Microbiology, Mosby, 1994; and R. M. Atlas, Handbook of Microbiological Media, CRC Press; 3rd ed., 2004.

In one embodiment a sample obtained from a source animal is tested prior to culture to determine the number and diversity of microorganisms present. For example, a portion of the sample may be subjected to cell or molecular analysis, such as polymerase chain reaction (PCR) analysis, to characterize the microorganisms present. Following obtention of an amplified microorganism culture, cell or molecular analysis, such as a PCR analysis, may be performed to determine the diversity of the amplified culture. Comparison of first and second PCR analyses may be performed to ascertain the number and diversity of microorganism species present in the sample and the amplified culture. This information may be used, for instance, to modify culture conditions to achieve a greater diversity in the amplified culture.

Cell analysis of a sample of microorganisms may include standard microbiological analysis, for instance growing a sample on a selective medium, microscopic examination, and/or staining. In addition other molecular techniques are applicable in analysis of microorganisms, such as isolation of nucleic acids and Southern or Northern blotting.

Cell and molecular analysis of microorganism samples and culture samples may be performed according to standard techniques. Exemplary protocols and conditions for PCR and other analyses of gut microorganisms are set forth in references such as J. Sambrook et al., Molecular Cloning: A Laboratory Manual, Cold Spring Harbor Laboratory Press; 3rd ed., 2001; Eckburg, P. B., et al., Diversity of the Human Intestinal Microbial Flora, Science. 308: 1635-1638, 2005; Nordgard, L. et al., Nucleic Acid isolation from ecological samples-vertebrate gut flora, Methods Enzymol., 395:38-48, 2005; Anderson, K L et al, Comparison of rapid methods for the extraction of bacterial DNA from colonic and caecal lumen contents of the pig, J. Appl. Microbiol., 94(6):988-93, 2003; McOrist, A L et al., A comparison of five methods for extraction of bacterial DNA from human faecal samples, J Microbiol Methods, 50(2):131-9, 2002; Yu, Z and Morrison, M, Improved extraction of PCR-quality community DNA from digesta and fecal samples, Biotechniques, 36(5):808-12, 2004; Hume M E et al., Poultry digestive microflora biodiversity as indicated by denaturing gradient gel electrophoresis, Poult Sci., 82(7):1100-7, 2003 and Sharma, R, et al., Extraction of PCR-quality plant and microbial DNA from total rumen contents, Biotechniques, 34(1):92-4, 96-7, 2003.

Optionally, particular microorganisms are selected for during an amplification step such that an amplified culture is enriched in a particular microorganism compared to the sample obtained from the source animal.

A sample of microorganisms obtained from the digestive system of a source animal is a complex mixture of microorganisms. Among the microorganisms in the sample may be a bacterium, a protozoan, a yeast, a fungus, a bacterial spore, a protozoal spore, a yeast spore, a fungal spore, or combinations of these. Further diverse species of these organisms are present in the digestive system of the animal from which the sample is taken. Thus, in one embodiment, diverse species of microorganisms are included in an inventive composition. In a preferred embodiment, more than one species of microorganism is included in an inventive composition. In a further preferred embodiment, 2-4 species of microorganism are included, and more preferably, 5 or more species of microorganism are included in an inventive composition.

In a highly preferred embodiment, at least 50% of the total number of species represented in a sample taken from the digestive system of the source animals are included in a composition according to the invention. Further preferred is an embodiment in which at least 75% of the total number of species represented in a sample taken from the digestive system of the source animals are included in a composition according to the invention. Additionally preferred is an embodiment in which at least 85% of the total number of species represented in a sample taken from the digestive system of the source animals are included in a composition according to the invention. Also preferred is an embodiment in which at least 85-100% of the total number of species represented in a sample taken from the digestive system of the source animals are included in a composition according to the invention.

Among the microorganisms included in an inventive composition may be a bacterium, a protozoan, a yeast, a fungus, a bacterial spore, a protozoal spore, a yeast spore, a fungal spore, or combinations of these.

A probiotic composition is formulated such that living microorganisms are delivered to provide a benefit to the consuming animal. For example, a probiotic composition may be formulated to target delivery of at least a portion of the microorganisms to a region of the digestive system in order to promote colonization of the region by at least some of the microorganisms. Further, microorganisms may provide other benefits such as release of metabolites beneficial to the consuming animal, inhibition of pathogenic organisms, stimulation of the immune system, and inhibition of inflammatory diseases, among others.

In a further embodiment, an inventive composition formulated as a probiotic includes a nutritive medium for at least some of the included microorganisms in order to support the microorganisms in a living state prior to delivery to a human or other recipient animal. Highly preferred is a nutritive medium which is a food consumed by the animal from which the microorganisms are obtained, especially a natural food found in the animal's natural wild habitat. An especially preferred nutritive medium includes a grass, preferably organically grown and minimally processed grass.

In a highly preferred embodiment the nutritive medium includes one or more foods traditionally consumed as a natural diet by the type of animal from which the microorganisms are obtained. Thus, for example where the sample is obtained from the digestive system of a ruminant, a culture medium includes a grass and/or ground plant, such as clover, or an extract thereof. A grass included as a nutritive medium is preferably an organically grown and minimally processed natural grass. Grasses which may be included in a nutritive medium include those of the family of “true grasses”, that is, those classified in the family Poaceae (also known as Graminae). Another exemplary component is a plant from the family Fabaceae, such as a clover and/or alfalfa, which may also be included in a culture medium for microorganisms. However, a culture medium preferably includes little or no cereal grain from the grass family. For instance, a preferred culture medium contains less than 5% of a cereal grain and further preferably contains less than 2%. Highly preferred is a culture medium which contains substantially no cereal grain. Further, since microorganisms are obtained from weaned animals, a nutritive medium contains substantially no milk, milk products or milk components.

In an embodiment in which a composition is formulated as a probiotic, at least a portion of the microorganisms are provided as living or preserved microorganisms. Preserved microorganisms include dried, freeze-dried and spore forms, for example.

A composition may be formulated such that a unit dose of the composition contains a specified number of microorganisms. For example, a composition may contain a number of microorganisms in the range from about 1 to about 10×10¹² microorganisms per gram.

An inventive composition may further include a carrier formulated to be non-toxic to the animal intended to use the composition. The term “carrier” as used herein is intended to refer to a substance and/or article that facilitates administration of the microorganisms by providing a medium for their conveyance to the consuming animal. Further, a carrier is generally substantially non-toxic to an intended recipient in amounts employed and does not significantly inhibit the intended probiotic value of microorganisms in the composition. In general, a carrier is formulated such that microorganisms remain intact prior to administration of the composition.

In a preferred embodiment, a carrier is a nutritive medium for microorganisms included in an inventive composition as described above. In a highly preferred embodiment, the carrier which is a food source for microorganisms is also a food consumed by the animal from which the microorganisms were obtained.

An inventive composition is suitable for administration to the gastrointestinal system of a consuming animal by a variety of routes including through the mouth and anus depending on the composition and intended effect of the delivery.

As noted above, such carriers may be formulated to target the delivery of the plurality of microorganisms to a specified portion of the digestive system of the consuming animal. Microorganisms may be provided in a carrier having an enteric coating. For example, time-delayed release formulations may include a carrier formulated to release all or a portion of the microorganisms in a specified portion of the digestive system such as the mouth, the esophagus, the pharynx, the stomach, the small intestine, the large intestine, or combinations of these or subportions of these, such as the colon.

Compositions suitable for delivery may be formulated in various forms illustratively including physiologically acceptable aqueous or nonaqueous solutions, dispersions, suspensions or emulsions, and sterile powders for reconstitution into solutions or dispersions. Examples of suitable aqueous and nonaqueous carriers; diluents; solvents; or vehicles include water, ethanol, polyols such as propylene glycol, polyethylene glycol, glycerol, and the like, suitable mixtures thereof; vegetable oils such as olive oil; and injectable organic esters such as ethyloleate. Proper fluidity can be maintained, for example, by the use of a coating such as lecithin for a solid composition, by the maintenance of the required particle size in the case of dispersions, and by the use of surfactants such as sodium lauryl sulfate.

These compositions may also contain adjuvants such as preserving, wetting, emulsifying, and dispensing agents. It may also be desirable to include isotonic agents, for example, sugars, sodium chloride, and the like.

Solid dosage forms for oral administration include capsules, tablets, pills, powders, and granules. In such solid dosage forms, an inventive conjugate is admixed with at least one inert customary excipient (or carrier) such as sodium citrate or dicalcium phosphate or (a) fillers or extenders, as for example, starches, lactose, sucrose, glucose, mannitol, and sialicic acid, (b) binders, as for example, carboxymethylcellulose, alignates, gelatin, polyvinylpyrrolidone, sucrose, and acacia, (c) humectants, as for example, glycerol, (d) disintegrating agents, as for example, agar-agar, calcium carbonate, potato or tapioca starch, plant starches, alginic acid, certain complex silicates, and sodium carbonate, (e) solution retarders, as for example, paraffin, (f) absorption accelerators, as for example, quaternary ammonium compounds, (g) wetting agents, as for example, cetyl alcohol, and glycerol monostearate, and glycols (h) adsorbents, as for example, kaolin and bentonite, and (i) lubricants, as for example, talc, calcium stearate, magnesium stearate, solid polyethylene glycols, sodium lauryl sulfate, or mixtures thereof. In the case of capsules, tablets, and pills, the dosage forms may also comprise buffering agents.

Solid compositions of a similar type may also be employed as fillers in soft and hard-filled gelatin capsules using such excipients as lactose or milk sugar as well as high molecular weight polyethyleneglycols, and the like.

Solid dosage forms such as tablets, dragees, capsules, pills, and granules can be prepared with coatings and shells, such as enteric coatings and others well known in the art. They may contain opacifying agents, and can also be of such composition that they release the active compound or compounds in a certain part of the intestinal tract in a delayed manner, as noted above. Examples of embedding compositions which can be used are polymeric substances and waxes. The microorganisms can also be in micro-encapsulated form, if appropriate, with one or more of the above-mentioned excipients.

An enteric coating is typically a polymeric material. Preferred enteric coating materials have the characteristics of being bioerodible, gradually hydrolyzable and/or gradually water-soluble polymers. The amount of coating material applied to a solid dosage generally dictates the time interval between ingestion and drug release. A coating is applied with to a thickness such that the entire coating does not dissolve in the gastrointestinal fluids at pH below 5 associated with stomach acids, yet dissolves above pH 5 in the small intestine environment. It is expected that any anionic polymer exhibiting a pH-dependent solubility profile is readily used as an enteric coating in the practice of the present invention to achieve delivery of the microorganisms to the lower gastrointestinal tract. The selection of the specific enteric coating material depends on properties such as resistance to disintegration in the stomach; impermeability to gastric fluids and microorganism diffusion while in the stomach; ability to dissipate at the target intestine site; physical and chemical stability during storage; non-toxicity; and ease of application.

Suitable enteric coating materials illustratively include cellulosic polymers such as hydroxypropyl cellulose, hydroxyethyl cellulose, hydroxypropyl methyl cellulose, methyl cellulose, ethyl cellulose, cellulose acetate, cellulose acetate phthalate, cellulose acetate trimellitate, hydroxypropylmethyl cellulose phthalate, hydroxypropylmethyl cellulose succinate and carboxymethylcellulose sodium; acrylic acid polymers and copolymers, preferably formed from acrylic acid, methacrylic acid, methyl acrylate, ammonium methylacrylate, ethyl acrylate, methyl methacrylate and/or ethyl; vinyl polymers and copolymers such as polyvinyl pyrrolidone, polyvinyl acetate, polyvinylacetate phthalate, vinylacetate crotonic acid copolymer, and ethylene-vinyl acetate copolymers; shellac; and combinations thereof. Particularly preferred enteric coating materials for use herein are those acrylic acid polymers and copolymers available under the trade name EUDRAGIT®, Roehm Pharma (Germany). The EUDRAGIT® series L, L-30D and S copolymers are most preferred since these are insoluble in stomach and dissolve in the intestine.

An enteric coating provides for controlled release of microorganisms, such that release is accomplished at a predictable location in the lower intestinal tract below the point at which release would occur absent the enteric coating. The enteric coating also prevents exposure of the microorganisms and carrier to the epithelial and mucosal tissue of the mouth, pharynx, esophagus, and stomach, and to the enzymes associated with these tissues, if desired. The enteric coating therefore helps to protect the microorganisms prior to drug release at the desired site of delivery.

Furthermore, the coated solid dosages of the present invention allow optimization of microorganism delivery. Multiple enteric coatings targeted to release the microorganisms at various regions in the lower gastrointestinal tract would enable even more effective and sustained improved delivery throughout the lower gastrointestinal tract.

The enteric coating optionally contains a plasticizer to prevent the formation of pores and cracks that allow the penetration of the gastric fluids into the solid dosage. Suitable plasticizers illustratively include, triethyl citrate (Citroflex 2), triacetin (glyceryl triacetate), acetyl triethyl citrate (Citroflec A2), Carbowax 400 (polyethylene glycol 400), diethyl phthalate, tributyl citrate, acetylated monoglycerides, glycerol, fatty acid esters, propylene glycol, and dibutyl phthalate. In particular, a coating composed of an anionic carboxylic acrylic polymer typically contains approximately 10% to 25% by weight of a plasticizer, particularly dibutyl phthalate, polyethylene glycol, triethyl citrate and triacetin. The coating can also contain other coating excipients such as detackifiers, antifoaming agents, lubricants (e.g., magnesium stearate), and stabilizers (e.g., hydroxypropylcellulose, acids and bases) to solubilize or disperse the coating material, and to improve coating performance and the coated product.

The enteric coating is applied to a solid dosage using conventional coating methods and equipment. For example, an enteric coating can be applied to a solid dosage using a coating pan, an airless spray technique, fluidized bed coating equipment, or the like. Detailed information concerning materials, equipment and processes for preparing coated dosage forms may be found in Pharmaceutical Dosage Forms: Tablets, Lieberman et al. eds., New York: Marcel Dekker, Inc., 1989, and in L. V. Allen et al., Ansel's Pharmaceutical Dosage Forms and Drug Delivery Systems, Lippincott Williams & Wilkins, 8th ed., Philadelphia, (2004).

Liquid dosage forms for oral administration include a carrier formulated as an emulsion, solution, suspension, syrup, or elixir. In addition to the microorganisms, the liquid dosage forms may contain inert diluents commonly used in the art, such as water or other solvents, buffers, solubilizing agents and emulsifiers, as for example, ethyl alcohol, isopropyl alcohol, ethyl carbonate, ethyl acetate, benzyl alcohol, benzyl alcohol, benzyl benzoate, propyleneglycol, 1,3-butyleneglycol, dimethylformamide, oils, in particular, cottonseed oil, groundnut oil, corn germ oil, olive oil, castor oil and sesame oil, glycerol, tetrahydrofurfuryl alcohol, polyethyleneglycols and fatty acid esters of sorbitan or mixtures of these substances, and the like.

Besides such inert diluents, the composition can also include adjuvants, such as wetting agents, emulsifying and suspending agents, sweetening, flavoring, and perfuming agents.

Suspensions, in addition to an inventive conjugate, may contain suspending agents, as for example, ethoxylated isostearyl alcohols, polyoxyethylene sorbitol and sorbitolan esters, microcrystalline cellulose, aluminum metahydroxide, bentonite, agar-agar and tragacanth, or mixtures of these substances, and the like.

Further examples and details of pharmacological formulations and ingredients are found in standard references such as: A. R. Gennaro, Remington: The Science and Practice of Pharmacy, Lippincott Williams & Wilkins, 20th ed. (2003); L. V. Allen et al., Ansel's Pharmaceutical Dosage Forms and Drug Delivery Systems, Lippincott Williams & Wilkins, 8th ed., Philadelphia, (2004); J. G. Hardman et al., Goodman & Gilman's The Pharmacological Basis of Therapeutics, McGraw-Hill Professional, 10th ed. (2001).

Probiotic Methods

In one embodiment, an inventive method is provided for creating a probiotic composition for use by humans to support health, which includes securing a source animal that has been a traditional source of food for humans and that has been feeding from naturally occurring food in its native habitat.

Further included is obtaining a sample of microorganisms from the digestive system of the source animal. The microorganisms so obtained may be included directly in a probiotic composition and/or amplified for inclusion in a probiotic composition.

For example, a fresh raw sample of at least partially digested contents of the intestine is obtained from the source animal intestine and microorganisms are extracted from the partially digested contents. The microorganisms may be grown on a medium comprising a naturally occurring food typically consumed by the source animal in its native habitat. In one option, bacteria are selected for and other organisms are excluded from an inventive composition.

In a further embodiment, a method of creating a probiotic composition for use by humans to support health is provided which includes securing a source animal that has been a traditional source of food for humans and that has been feeding from naturally occurring food in its native habitat. A fresh raw sample of the inner wall of the animal intestine is obtained and a sample of microorganisms is isolated and optionally grown on a medium comprising the naturally occurring food. These grown microbacteria may be used as probiotics for use by humans.

One embodiment of a provided method of generating a microbial probiotic composition includes isolating a sample of microorganisms from the digestive system of a source animal and culturing the sample of microorganisms on a nutritive medium to obtain an amplified microorganism culture. Optionally included is isolating the amplified microorganism culture from the nutritive medium to yield a purified microorganism culture and introducing the purified microorganism culture into contact with a carrier. In a preferred embodiment, the source animal is a traditional food source of humans where the intended consumer is a human.

A method of promoting the health of an individual is provided which includes the steps of providing a composition including a quantity of microorganisms amplified from an isolated sample of microorganisms from the digestive system of a source animal and administering the composition to the gastrointestinal system of an individual of the second type of animal for which the source animal is a traditional food source.

Any patents or publications mentioned in this specification are incorporated herein by reference to the same extent as if each individual publication was specifically and individually indicated to be incorporated by reference.

Methods and compositions described herein are presently representative of preferred embodiments. Thus, they are exemplary and are not intended as limitations on the scope of the invention or inventions. Changes therein and other uses will occur to those skilled in the art. Such changes and other uses are encompassed within the spirit of the invention as defined by the scope of the claims.

I claim:

1. A probiotic composition, comprising:
a plurality of microorganisms isolated from a source animal having a native habitat, wherein the source animal is a traditional food source of a second type of animal; and
a carrier for the plurality of microorganisms.

2. The composition of claim 1, wherein the carrier comprises a nutritive medium for at least a portion of the plurality of microorganisms.

3. The composition of claim 2, wherein the nutritive medium comprises a food consumed by the source animal as part of a natural diet in the wild.

4. The composition of claim 2, wherein the nutritive medium comprises a grass.

5. The composition of claim 1, wherein the second type of animal is a human.

6. The composition of claim 1, wherein the source animal is a weaned ruminant.

7. The composition of claim 1, wherein the native habitat is Africa.

8. The composition of claim 6, wherein the weaned ruminant is selected from the group consisting of: a cow, a sheep, a goat, a bison, a buffalo, a cape buffalo, a deer, an elk, an antelope, a moose, and a llama.

9. The composition of claim 1, wherein the source animal is selected from the group consisting of: a pig, a chicken, a turkey, a game bird, a fish, a shellfish, a horse, a rodent, a rabbit, and a hare.

10. The composition of claim 1, wherein the source animal has been fed a natural diet over a period of time extending from weaning to a time at which microorganisms are isolated from the digestive system of the source animal.

11. The composition of claim 1, wherein the second type of animal is an animal commonly kept as a household pet.

12. The food composition of claim 11, wherein the source animal is selected from the group consisting of: a ruminant, a pig, a poultry animal, a bird, a fish, a rodent, a rabbit, a hare, a reptile and an amphibian.

13. A process for producing a probiotic composition, comprising:
isolating a sample of microorganisms from the digestive system of a source animal, wherein the source animal is a traditional food source of a second type of animal, to produce an isolated sample of microorganisms.

14. The process of claim 13, further comprising amplifying the isolated sample of microorganisms to produce an amplified sample of microorganisms.

15. The method of claim 13, further comprising contacting one or more foods typically consumed as a part of a natural diet of the source animal and the isolated sample of microorganisms.

16. The method of claim 14, further comprising contacting one or more foods typically consumed as a part of a natural diet of the source animal and the amplified sample of microorganisms.
